(19) United States
(12) Patent Application Publication
(10) Pub. No.: US 2012/0139281 A1
(43) Pub. Date: Jun. 7, 2012

(54) MODULAR RAMP ASSEMBLY FOR VEHICLE

(76) Inventors: Daniel P. Cousino, Carleton, MI (US); Henry W. Hausler, Manchester, MI (US)

(21) Appl. No.: 12/957,670

(22) Filed: Dec. 1, 2010

(51) Int. Cl. B62D 25/00

(52) U.S. Cl. 296/61

(57) ABSTRACT

A modular ramp assembly is provided for use in connection with a pickup truck cargo box. The ramp assembly has a ramp connector assembly provided on the vehicle tailgate and a ramp having a connector for connecting to the ramp connector to serve as a loading ramp. The ramp connector has a pivoting clevis bracket and tangs that connects into a channel on the tailgate. Additional connectors are provided in the vehicle cargo box for connecting to the ramp such that the ramp is configured to operate as a cross-member such as a shelf or divider in the cargo box.

### FIELD OF THE INVENTION

The present invention generally relates to vehicle ramp assemblies, and more particularly relates to a modular ramp assembly for loading items into a pickup truck cargo box.

### BACKGROUND OF THE INVENTION

Automotive vehicles, such as pickup trucks, are commonly employed with a cargo box or bed that may be used to transport various items such as motorcycles, all-terrain vehicles (ATVs), four-wheelers (quads), garden and lawn tractors and other items. Heavy items such as these typically require the use of a loading ramp to assist with the loading and unloading of each item, such as an ATV, into and out of the cargo box of the pickup truck. Truck operators typically employ wood planks or aftermarket ramps of sufficient strength to support the weight of the item being loaded. Aftermarket ramps are commercially available in many forms and made of materials, such as aluminum, steel and composites, and typically come in single or multi-piece pairs, often fixed or hingedly connected, and may have many different surface treatments to provide traction.

Conventional loading ramps typically have tips at one end that sit on the tailgate of the pickup truck and the opposite end rests on the ground. Many ramps are equipped with tether straps to secure the ramp relative to the vehicle. Straps may be cumbersome and are susceptible to being cut or lost. Additionally, conventional ramps typically need to be secured or stored and may be prone to theft if left unsecured in a cargo area. Further, conventional ramps are often stored off the vehicle which may make the ramp inaccessible and inconvenient to the vehicle operator.

Accordingly, it is desirable to provide for modular loading ramps that are easy to use on a vehicle without drawbacks associated with the conventional ramps and that may be conveniently stored on the vehicle and easily made available to a user.

### SUMMARY OF THE INVENTION

According to one aspect of the present invention, a ramp assembly for use with a vehicle is provided. The ramp assembly includes a channel provided on a vehicle and having one or more enlarged openings, a ramp, and a ramp connector provided on the ramp. The ramp connector includes one or more tangs configured to fit in the one or more enlarged openings and retained within the channel to hold the ramp in place on the vehicle.

According to another aspect of the present invention, a modular ramp assembly for use on a pickup truck is provided. The modular ramp assembly includes a vehicle tailgate having a tailgate connector. The ramp assembly also includes a ramp having a ramp connector for connecting to the tailgate connector to serve as a loading ramp. The ramp assembly further includes one or more connectors provided in the vehicle cargo box for connecting to the ramp such that the ramp is configured to operate as a cross-member in the cargo box.

According to a further aspect of the present invention, a method of using and storing a ramp for use on a vehicle pickup truck is provided. The method includes the steps of aligning a ramp with a tailgate of a pickup truck, connecting a pivoting clevis bracket at one end of the ramp into a channel in the tailgate, and sliding the ramp within the channel to a trapped position. The method also includes the steps of removing the ramp from the tailgate, storing the ramp in a wall of the cargo box and connecting the pivoting clevis bracket into another channel in a wall of the cargo box to form a cross-member.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a rear side perspective view of a pickup truck cargo box having a ramp assembly with a pair of loading ramps attached to the tailgate, according to one embodiment;

FIG. 2 is a side view of the truck and loading ramp assembly in FIG. 1 shown in loading positions;

FIG. 3 is an enlarged top view of the loading ramp assembly showing the connection to the vehicle tailgate;

FIG. 4 is a bottom perspective view of the loading ramp having ramp connectors with pivoting clevis brackets and tangs connectors on opposite ends, according to one embodiment;

FIG. 5 is an enlarged exploded assembly view of one end of the ramp further illustrating the pivoting bracket ramp connector;

FIG. 6 is a cross-sectional view taken through line VI-VI of FIG. 3 illustrating assembly of the ramp to the tailgate channel via an enlarged opening;

FIG. 7 is a cross-sectional view taken through line VII-VII of FIG. 3 illustrating locked engagement of the ramp to the tailgate channel;

FIG. 8 is a rear perspective of the vehicle cargo box with one ramp stored in an inner side wall, according to a first embodiment;

FIG. 9 is an enlarged partial view of the side wall and ramp of FIG. 8 further illustrating connection of the ramp to the cargo box side wall;

FIG. 10 is a rear perspective view of the cargo box illustrating storage of one ramp to an inner side wall, according to a second embodiment;

FIG. 11 is an enlarged partial view of one end of the side wall and ramp of FIG. 10 further illustrating connection of the ramp to the cargo box side wall;

FIG. 12 is a rear perspective view of the vehicle cargo box having a pair of ramps oriented to form cross-members in the form of shelves shown in multiple positions, according to one embodiment;

FIG. 13 is an enlarged top view of one end of a ramp to be assembled to the cargo box to form a shelf;

FIG. 14 is a rear perspective view of a ramp assembled to the cargo box side walls to form a cross-member in the form of a divider, according to one embodiment;

FIG. 15 is an enlarged top view of one end of a ramp to be assembled vertically to the cargo box side wall to form a divider; and

FIG. 16 is an enlarged top perspective view of one end of the ramp forming a divider further shown assembled to the side wall of the vehicle cargo box.

### DETAILED DESCRIPTION OF PREFERRED EMBODIMENTS

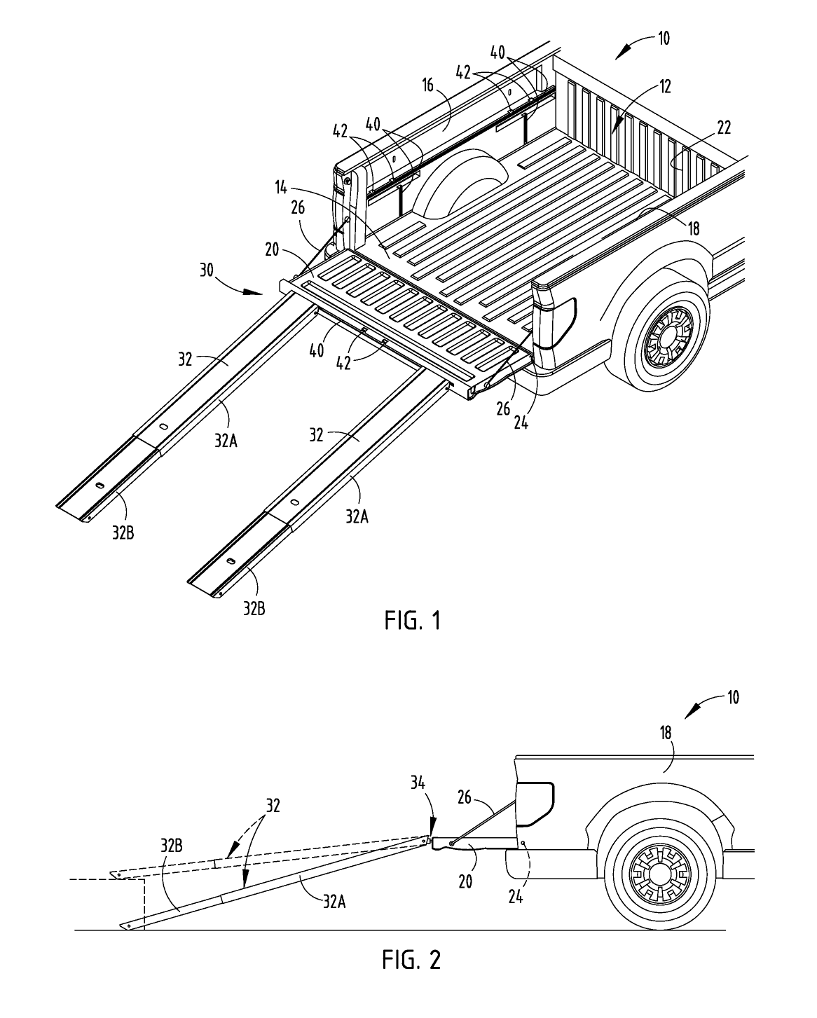

For purposes of description herein, the terms “upper,” “lower,” “right,” “left,” “rear,” “front,” “vertical,” “horizontal,” and derivatives thereof shall relate to the vehicle and ramp assembly as oriented in FIGS. 1 and 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIGS. 1 and 2, an automotive vehicle 10 in the form of a pickup truck is shown having a cargo box or bed 12 and equipped with a modular ramp assembly 30 arranged in the loading position, according to one embodiment. The cargo box 12 has a bottom floor 14 and four side walls 16, 18, 20 and 22 that generally define the shape of the box 12. The front wall 22 is adjacent to and rearward of the vehicle cab. The lateral side walls 16 and 18 are parallel to each other and generally extend above the rear wheel wells. The rear wall 20 is provided by a pivoting tailgate which pivots between a downward open position shown generally horizontal in FIG. 1 and an upright vertical closed position to serve as the rear wall of the cargo box 12. The tailgate 20 may include a conventional tailgate having a pair of hinge pivots 24 on opposite left and right side near the bottom edge and a support cable 26 at each end to support the tailgate 20 when in the open horizontal position. The hinge pivots 24 may each include a hinge socket and pivot bracket that allows the tailgate 20 to pivot about the bottom edge relative to a supporting vehicle structure, such as a D-pillar, and may be keyed to allow removal of the tailgate 20 from the vehicle 10. The hinge pivots 24 may include a lift assist mechanism such as a tension rod or spring.

In the embodiment shown, the ramp assembly 30 has a pair of ramps 32 configured for assembly to a retaining channel 40 in tailgate 20 when the tailgate 20 is in the downward horizontal position to enable cargo items to be loaded on the ramps 32 into and out of the cargo box 12. However, it should be appreciated that the ramp assembly 30 may otherwise be configured to connect the ramps 32 directly to the floor 14, or other wall or surface leading to the cargo box 12 of the vehicle 10. It is contemplated that the tailgate 20 may be removed from the vehicle by disengaging the hinge pivots 24 and cables 26 such that the ramps 32 may be connected to a channel provided at the rear end of the floor 14, according to another embodiment.

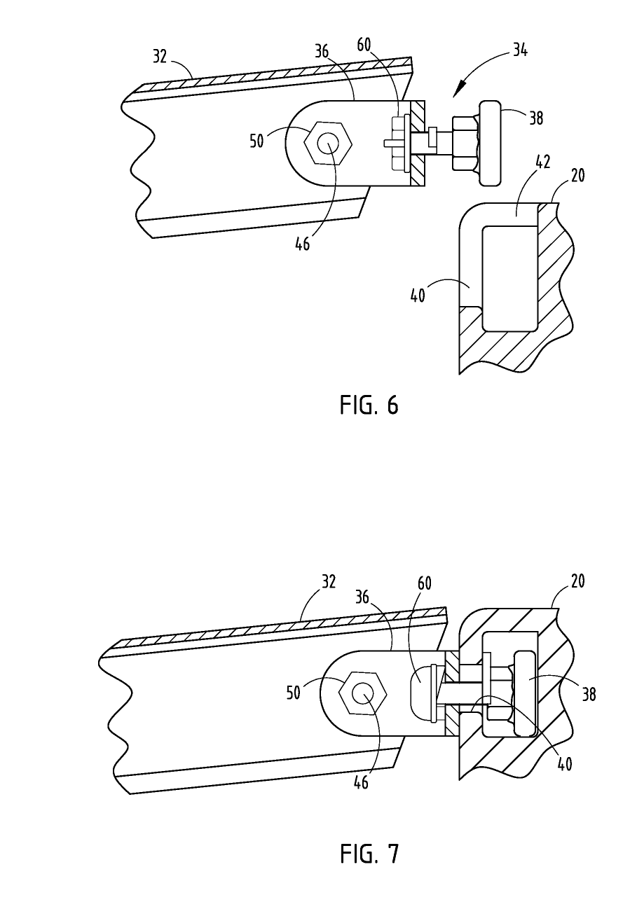

In the embodiment shown, the tailgate 20 has a channel 40 formed in the outer wall at the outermost end of the tailgate 20. The channel 40 has a C-shaped cross-section and extends a substantial length of the tailgate 20 and allows for the retention of a ramp connector 34 having a pivoting clevis bracket and a pair of generally T-shaped tangs provided at ends of the ramps 32 to retain the ramps 32 in a desired position. The channel 40 has a pair of enlarged notches or openings 42 formed in an inner wall surface of the tailgate 20 as shown in FIG. 1. The openings 42 are sized and spaced to allow for the receipt of the pair of T-shaped tangs 38 on the pivoting clevis bracket 36. As seen in FIG. 6, the pair of T-shaped tangs 38 is inserted through the pair of openings 42 and into the channel 40. Once the T-shaped tangs 38 are inserted into channel 40 at the enlarged openings 42, each ramp 32 may slide laterally within the channel 40 to a position away from the openings 42 such that the T-shaped tangs 38 are matingly engaged with and trapped within the channel 40 as shown in FIG. 7. Accordingly, each ramp 32 may be engaged to the tailgate 20 by placing the pair of T-shaped tangs 38 into the pair of spaced, enlarged openings 42 shown at or near the center of the tailgate 20 to be matingly engaged within channel 40 and sliding the ramp left or right within channel 40 to a desired position to load cargo items, such as an ATV into the cargo box 12 of the vehicle 10. First, a left ramp may be installed in openings 42 and moved left within channel 40, and then a second ramp may be inserted into openings 42 moved to the right within channel 40 to define a pair of spaced apart ramps as shown in FIG. 1. It should be appreciated that the enlarged pair of openings 42 may be located elsewhere in communication with the channel 40 and that more than one pair of openings may be provided in communication with channel 40.

The ramps 32 are each shown provided as a telescoping ramp made up of a first section 32A slidingly engageable with and retained to a second section 32B. Ramp sections 32A and 32B are generally planar on top and have side walls that retain one section within the other section. The length of each ramp 32 may be adjusted by sliding ramp section 32B relative to ramp section 32A to realize a desired angle and position of the ramp 32. Additionally, the ramp 32 may pivot about the pivoting clevis bracket 34 as seen in FIG. 2. Accordingly, the ramps 32 may pivot to accommodate different elevations, such as the ground or a porch to change the angle of the ramp 32 as desired.

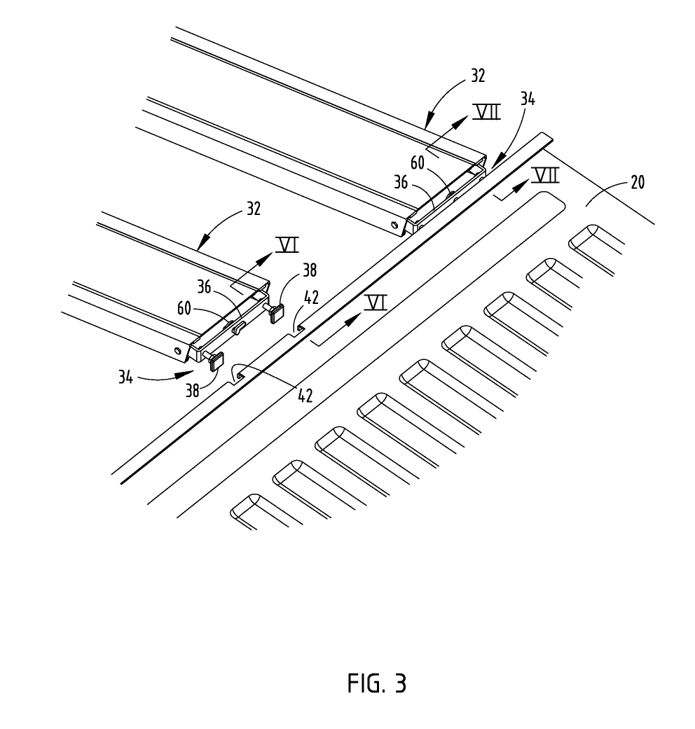

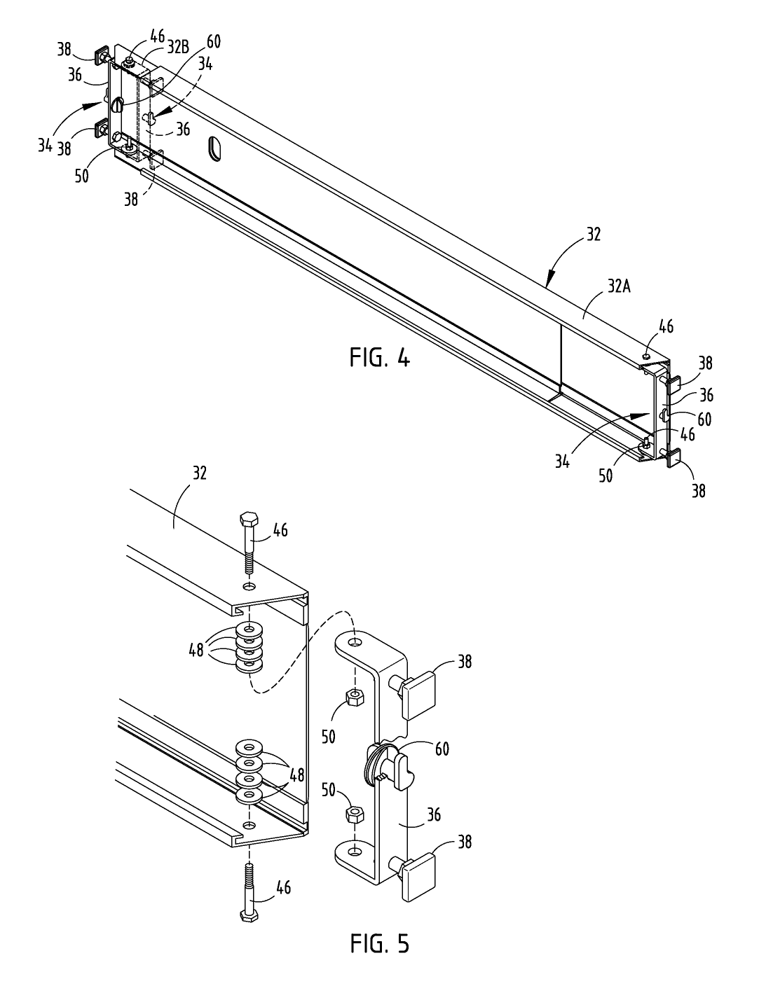

The assembly of each of the ramps 32 to the vehicle tailgate 20 into the loading position is illustrated in FIG. 3 with the ramp connector 34 of one ramp 32 matingly engaged with the retaining channel 40 and slid into a desired position on one side of the tailgate 20, and the other ramp 32 positioned for insertion into openings 42 to be installed in the retaining channel 40 in tailgate 20. Pivoting ramp connectors 34 are provided at opposite ends of the ramp 32 as shown in FIG. 4. Referring to FIG. 5, each pivoting ramp connector 34 has a U-shaped clevis bracket 36 pivotally connected to the ramp 32 via bolt 46, washers 48, and nut 50 such that bracket 36 is allowed to pivot about bolt 46 between an outward extended position and an inward stowed position as shown in dashed lines in FIG. 4. Accordingly, one end of the ramp 32 may connect via the pivoting ramp connector 34 to the tailgate 20 of the vehicle 10 in the extended outward position, and the other ramp connector 34 at the opposite end of the ramp 34 may be in the inward stowed position when used as a loading ramp. Thus, either end of ramp 32 may be connected via ramp connector 34 to the channel 40 of the tailgate connector. The U-shaped bracket 36 has a pair of T-shaped connectors 38, as seen in cross section, connected thereto for matingly engaging the opening 42 and C-shaped channel 40 in the embodiment shown. While a pair of T-shaped tangs is shown, it should be appreciated that other shaped connectors such as rectangular, oval, round or other cross sectioned shapes may be employed as connectors 38. A round shaped tang may allow for use as or with a bearing such that the round tang may spin within channel 40.

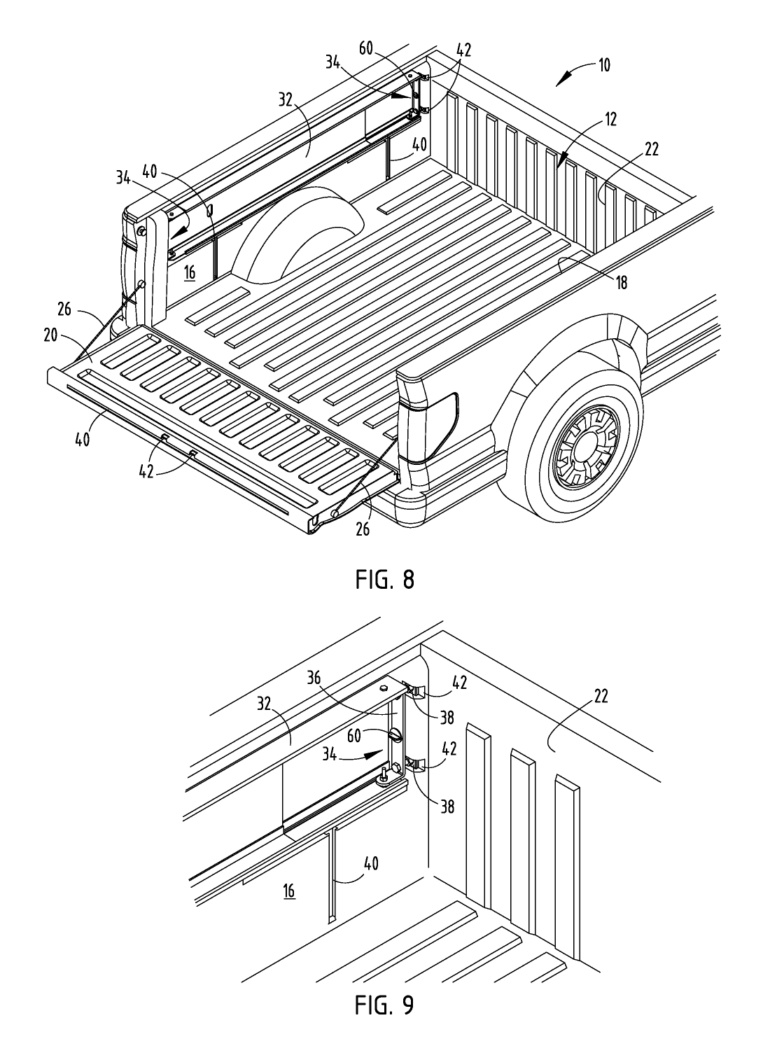

The ramp connector 34 is further shown in FIGS. 5-7 having a cam shaped twist lock 60 connected to the U-shaped clevis bracket 36. The cam-shaped twist lock 60 is shown having a threaded member that may be twisted to move outward from bracket 36 to form a frictional lock between the ramp connector 34 and a mounting surface, such as the tailgate 20 of vehicle 10. The cam-shaped twist lock 60 is used to hold each of the ramps 32 in place against the tailgate 20 once positioned at the desired location so that the ramp 32 does not move during the loading and unloading process. Additionally, the cam-shaped twist lock 60 may be used to hold a shelf or divider in place from sliding by turning the twist lock to form a frictional engagement with a portion of a cargo box. The cam-shaped twist lock may further be used to frictionally engage the cargo box side walls when stored therein as shown in FIGS. 8 and 9 to prevent relative movement between the ramps 32 and walls. The cam-shaped twist lock 60 may have various shapes and sizes for forming a frictional locking member and may be equipped with a keyed lock set for security to lock each of the ramps 32 onto the inner walls 16 and 18 of the cargo box 12 when used with the ramps 32. It should be appreciated that the twist lock 60 may include enhanced frictional materials, such as rubber or other frictional material that prevents sliding of the ramp relative to the tailgate 20 during use.

The ramp assembly 30 advantageously provides for a pair of ramps 32 that may be removably installed on the tailgate 20 of the vehicle 10 to allow for the loading and unloading of items into the cargo box 12. Ramps 32 may be easily removed by a user from the C-shaped channel 40 through openings 42 of the tailgate connector. The removed ramps 32 may be stowed within the inner side of the lateral walls 16 and 18 of cargo box 12 as seen in FIGS. 8 and 9, according to one embodiment. In this embodiment, the pivoting ramp connectors 34 are deployed in their outward extending positions at opposite ends of each ramp 32 and the connectors 34 are installed through openings 42 into a vertical channel 40 formed in the lateral side walls 16 and 18. In the two ramp embodiments, one ramp 32 is installed in inner side wall 16 and the other ramp 32 is installed in inner side wall 18. Each vertical channel 40 receives the pair of T-shaped tang connectors 38 at opening 42 as best seen in FIG. 9 and the ramp 32 drops downward and is retained by the T-shaped tang connectors 38 of ramp 32 trapped within channel 40. Thus, the pair of ramps 32 are retained in place stored within the cargo box 12 adjacent the vehicle side walls for convenient storage and transportation of the ramps. A user may conveniently remove the ramps 32 from the tailgate 20 when desired and restore the ramps 32 in the side walls 16 and 18 of the cargo box 12 and vice versa.

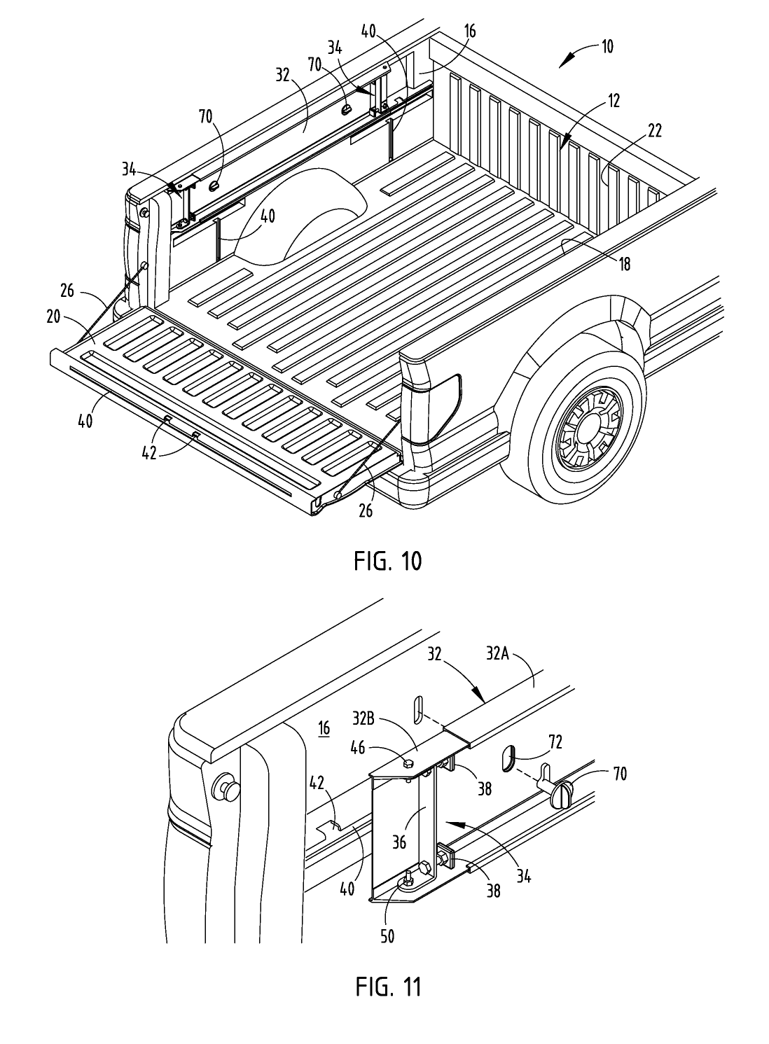

Referring to FIGS. 10 and 11, the ramps 32 are shown stored within the side walls 16 and 18 with a pair of twist lock connectors 70, according to a second embodiment. In this embodiment, the twist lock connectors 70 are insertable through openings 72 in the ramp 32 and into threaded openings in wall 16 or 18 and may be twisted by a predetermined angle, such as ninety degrees (90°), to lock the connectors 70 and ramp 32 in place. Thus, twist lock connectors 70 retain the loading ramp 32 positioned against the inner surface of the lateral wall. The twist lock connectors 70 may be locked to the side wall 16 or 18 via a locking mechanism to prevent theft or unauthorized removal of the ramp 32. Also, in this position, the pivoting ramp connectors 34 may be positioned in the inward stowed positions.

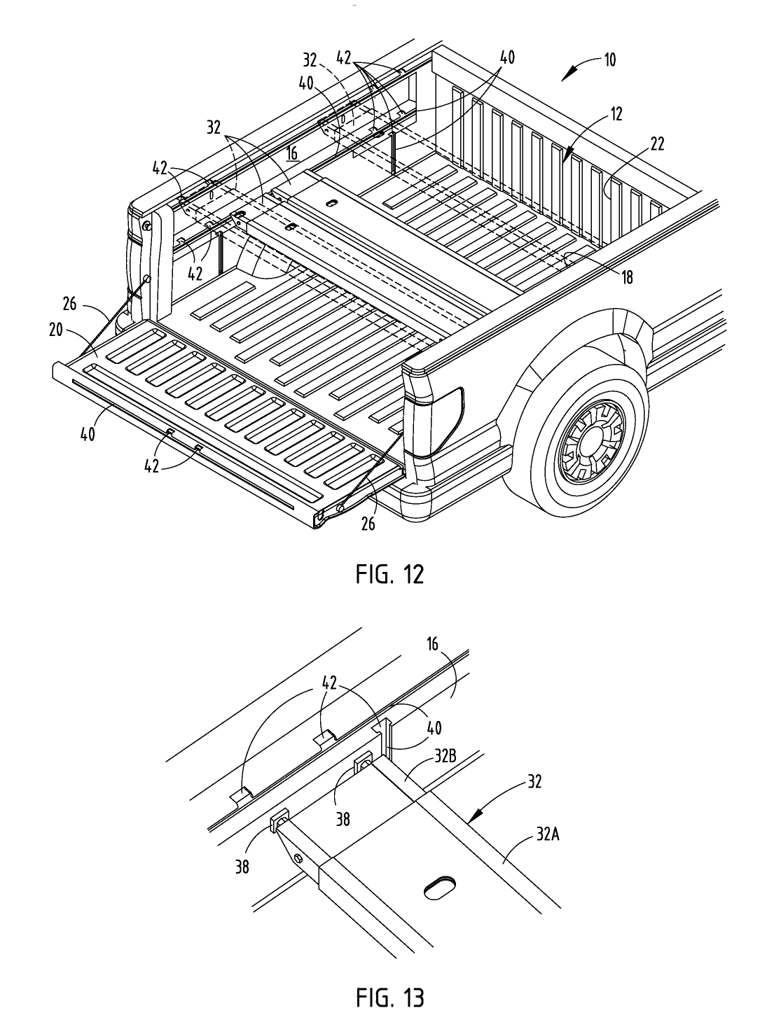

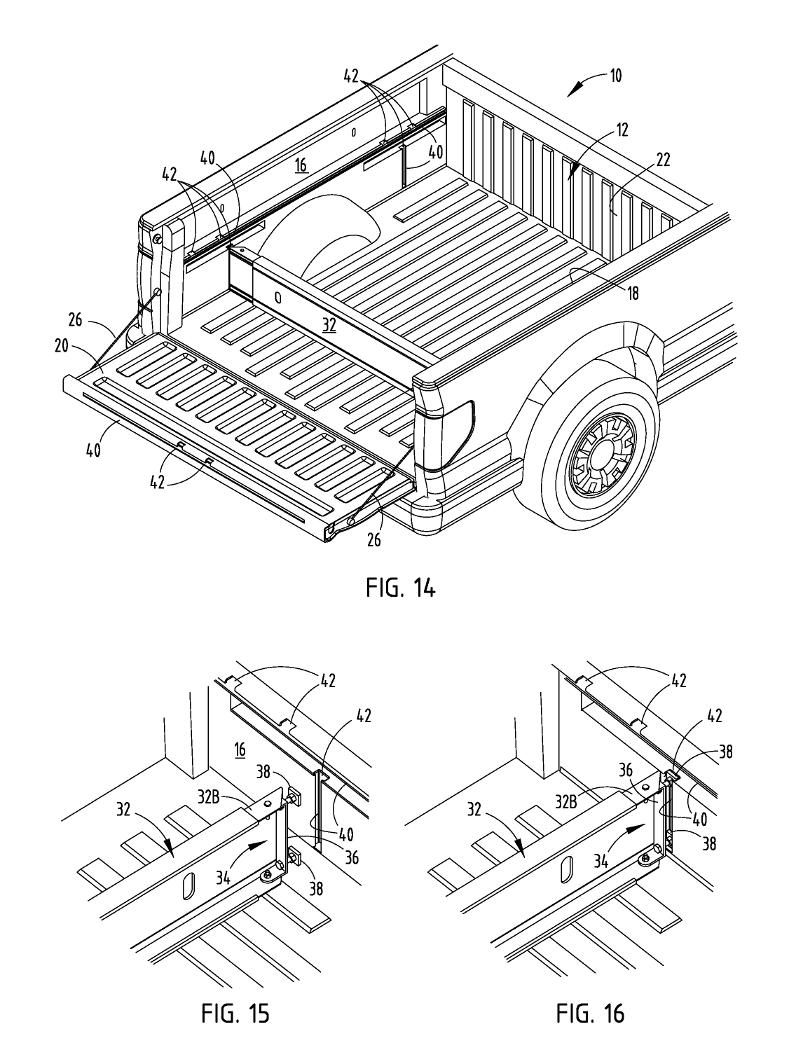

The ramp assembly 30 is modular in that the ramps 32 are also employable to operate as cross-members in the cargo box 12. A cross-member may serve as a shelf as shown in FIGS. 12 and 13 or as a divider member as seen in FIGS. 14-16. Referring specifically to FIGS. 12 and 13, the ramps 32 are shown installed within horizontal C-shaped retaining channels 40 of cargo box connectors on opposite side walls 16 and 18 by engaging the outward existing and pivoting clevis bracket and T-shaped tangs 38 of ramp connector 34 within the channel 40 by insertion through openings 42 to form one or more shelves. The ramps 32 may slide within the horizontal channel 40 to a desired shelf position. The cargo box 12 may include two horizontal channels 40 each having an enlarged opening 42 at two or more different elevations to provide different height shelves as shown by solid and dashed lines in FIG. 12. Accordingly, objects may be placed upon the shelves 32 which may be positioned at various positions within the cargo box 12. It should also be appreciated that the length of each shelf 32 may be changed to accommodate the bed shape by extending or retracting the length of the ramps 32.

Referring to FIGS. 14-16, the ramp 32 is shown provided as a vertical wall or divider member which may serve to divide cargo or retain cargo within the cargo box 12. In this application, the pivoting clevis bracket 36 and its T-shaped tangs 38 of the ramp connectors 34 are inserted through openings 42 and into vertical retaining channels 40 of the cargo box on opposite side walls 16 and 18 and retained in place by the vertical channels 40 as shown. One, two or more vertical channels 40 may be provided in each of the side walls 16 or 18 for matingly engaging the ramp connectors 34 to form the divider walls. It should further be appreciated that ramp 32 may be connected to extend longitudinally to provide a left and right side divider connected to the front wall 22 and tailgate 20.

Accordingly, the loading ramp assembly 30 advantageously provides for an easy to use and store loading ramp assembly 30 for a pickup truck 10. The ramps 32 may be installed in the tailgate 20 of the vehicle 10 without the need for retaining straps and may be easily stored against an inner side wall of the lateral side walls 16 and 18 and out of the way in a manner that is efficiently stored. The ramps 32 may be further employed as a modular assembly to form one or more shelves and to form one or more dividers within the vehicle cargo box 12. It should further be appreciated that further connector locations and assemblies may be employed to retain the ramp members 32 in various orientations of the vehicle cargo box 12.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A ramp assembly for use with a vehicle, comprising:
a channel provided on a structure of a vehicle and having one or more enlarged openings;
a ramp; and
a ramp connector provided on the ramp and comprising one or more tangs configured to fit in the one or more enlarged openings and retained within the channel to hold the ramp in place on the vehicle.

2. The ramp assembly of claim 1, wherein the ramp connector comprises a pivoting clevis bracket having the one or more tangs attached thereto.

3. The ramp assembly of claim 2, wherein the channel comprises a C-shaped channel and the tang comprises a pair of T-shaped connectors for engaging the C-shaped channel through two openings.

4. The ramp assembly of claim 1, wherein the channel is provided in an end wall of a tailgate of the vehicle.

5. The ramp assembly of claim 1, wherein the ramp is extendable longitudinally to adjust length of the ramp.

6. The ramp assembly of claim 1, wherein the ramp may be stored on an inner wall of a truck cargo box.

7. The ramp assembly of claim 6, wherein the assembly comprises first and second connectors at opposite ends of the ramp.

8. The ramp assembly of claim 7, wherein each of the first and second connectors has a pivoting clevis bracket and one or more tangs that engage an opening in a side wall of the truck cargo box.

9. The ramp assembly of claim 7, wherein the ramp may be configured as one of a divider and a shelf, wherein the one or more tangs of each of the first and second connectors engage an opening in a side wall of a truck cargo box.

10. A modular ramp assembly for use on a pickup truck comprising:
a vehicle tailgate having a tailgate connector;
a ramp having a ramp connector for connecting to the tailgate connector to serve as a loading ramp; and
one or more cargo box connectors provided in the vehicle cargo box for connecting to the ramp such that the ramp is configured to operate as a cross-member in the cargo box.

11. The assembly as defined in claim 10, wherein the cross-member serves as a divider of the vehicle cargo box.

12. The assembly of claim 10, wherein the cross-member serves as a shelf on the vehicle cargo box.

13. The assembly of claim 10, wherein the tailgate connector comprises a channel having at least one enlarged opening and the ramp connector comprising at least one tang configured to pass into the enlarged opening and matingly engaging the channel.

14. The assembly of claim 13, wherein the channel has a C-shape and each tang has a T-shape.

15. The assembly of claim 10, wherein the ramp connector comprises a pivoting clevis bracket and the one or more tangs connects to the channel.

16. The assembly of claim 10, wherein the ramp connector comprises a first ramp connector at one end of the ramp and a second ramp connector as another opposite end of the ramp.

17. The assembly of claim 16, wherein the first and second ramp connectors are adapted to connect to first and second cargo box connectors in the vehicle cargo box.

18. The assembly of claim 10, wherein the ramp is adapted to connect to an inner wall of the cargo box for storage of the ramp.

19. A method of using and storing a ramp for use on a vehicle pickup truck comprising the steps of:
aligning a ramp with a tailgate of a pickup truck;
connecting a pivoting clevis bracket at one end of the ramp into a channel in the tailgate;
sliding the ramp within the channel to a trapped position;
removing the ramp from the tailgate;
storing the ramp in a wall of the cargo bed; and
connecting the pivoting clevis bracket into another channel in a wall of the cargo box to form a cross-member.

20. The method of claim 19, wherein the step of connecting the pivoting clevis bracket into another channel forms one of a shelf and a divider.
